(19) United States
(12) Patent Application Publication
(10) Pub. No.: US 2012/0301635 A1
(43) Pub. Date: Nov. 29, 2012

(54) TRANSPARENT PROTECTIVE PLATE FOR DISPLAY PANELS AND DISPLAY DEVICE

(75) Inventors: Hiroaki Hasegawa, Fukui (JP); Munetake Tajima, Fukui (JP); Hirokazu Hashimoto, Fukui (JP)

(73) Assignee: FUKUVI CHEMICAL INDUSTRY CO., LTD., Fukui (JP)

(21) Appl. No.: 13/575,410

(22) PCT Filed: Feb. 14, 2011
(86) PCT No.: PCT/JP2011/053010

§ 371 Date: Jul. 26, 2012

(30) Foreign Application Priority Data
Feb. 17, 2010 (JP) 2010-032775

(51) Int. Cl. G02F 1/1333; B32B 27/08; B32B 7/02

(52) U.S. Cl. 428/1.32; 428/448; 428/354; 428/213; 428/412

(57) ABSTRACT

To provide a highly transparent and highly strong protective plate for display panel which, when mounted on a display panel, does not permit bubbles to evolve in the inner layer or does not permit the layer to peel off even in high temperature and high humidity conditions that could temporarily occur, for example, in an automobile, and a display device equipped with the protective plate.

[Means for Solution] A transparent protective plate for display panel having an underlying layer, a gas-barrier layer and, as required, a transparent adhesive layer of an acrylic adhesive successively laminated on a transparent hard resin substrate such as of a polymethyl methacrylate resin or an aromatic polycarbonate resin, wherein the underlying layer comprises a cured body obtained by polymerizing an underlying material solution that contains 90 to 20 parts by mass of an urethane acrylate adhesive resin (A), and 10 to 80 parts by mass of a silicon compound (B) selected from the group consisting of an alkoxysilane compound and a hydrolyzed product thereof, a silane coupling agent and a hydrolyzed product thereof, and a fine particulate silica; and the gas-barrier layer comprises a cured body of a dense silicon oxide obtained by curing a polysilazane compound (C) in the presence of an amine catalyst (D).

### TECHNICAL FIELD

This invention relates to a display device having high durability in an environment of high temperatures and high humidity, and to a transparent protective plate for display panels that can be favorably used for the display device.

### BACKGROUND ART

Display panels such as liquid crystal panels and touch panels have, usually, been provided on the surfaces thereof with a protective layer, a protective film or a protective plate for various purposes. In the case of a cell phone, for example, to protect the liquid crystal panel from being broken by the external impact, a reinforced glass or acrylic plate covering (protective plate) is, usually, used, and a gap (air gap) is provided between the covering and the liquid crystal panel so that the liquid crystal panel will not be affected even if the covering is broken by the external impact (air-gap structure). The display panel is, further, fitted, as required, with a visual angle control film for narrowing the visual angle so will not to be peeped by other persons, transparent protective plate on which is laminated an antireflection filter for preventing reflection by the panel surface and for maintaining a visual field or a circularly polarizing filter, or a filter for expanding the visual angle.

The display panel having the air-gap structure mentioned above has resistance against impact accompanied, however, by such problems as a decease in the brightness and contrast due to the air gap that causes light to scatter, and a conspicuous decrease in the visibility specifically outdoors, making it difficult to fully realize the capability inherent in the liquid crystal panels. In order to solve these problems, technology has been developed to improve visibility while attaining impact resistance by filling a resin having controlled refractive index between a cover and a liquid crystal panel, or by holding a buffer sheet made of a transparent adhesive resin therebetween (air-gapless structure; non-patent document 1, patent document 1, patent document 2).

A display device for car navigation systems is basically used inside an automobile and is often exposed to high temperatures and high humidity in the summer and rainy seasons. When used in such an environment of high temperatures and high humidity, however, bubbles build up in the liquid display device of the above air-gapless structure causing the visibility to be deteriorated and often the transparent protective plate to be peeled off.

### PRIOR ART DOCUMENTS

### Patent Documents

Patent document 1: JP-A-9-133912
Patent document 2: JP-A-6-75210

### Non-Patent Document

Non-patent document 1: Elastic Optical Resin Developed Improving Visibility of the Liquid Crystal Display and Realizing Impact Resistance, Mass Production Starts: News Release [online]<URL:http://www.sonycid.jp/news07005.html>

### OUTLINE OF THE INVENTION

### Problems that the Invention is to Solve

In order to solve the above problems, the present inventors have forwarded keen study concerning the mechanism of bubbles that evolve in the display panel of the air-gapless structure and the cause of peeling, and have discovered the fact that water vapor and carbon dioxide gas evolve under high temperature and high humidity conditions, and diffuse into the transparent adhesive resin layer to stay therein as bubbles and often causing the transparent adhesive resin layer to be peeled off the display panel. The inventors have, further, discovered that the evolution of bubbles and peeling can be prevented by preventing the gas from diffusing into the transparent adhesive resin layer by using a special gas-barrier layer, and have completed the present invention.

### Means for Solving the Invention

According to the present invention, there is provided a transparent protective plate [I] for display panel having an underlying layer and a gas-barrier layer successively laminated on a transparent hard resin substrate, wherein:

the underlying layer comprises a cured body obtained by polymerizing an underlying material that contains 90 to 20 parts by mass of an urethane acrylate adhesive resin (A), and 10 to 80 parts by mass of at least one silicon compound (B) selected from the group consisting of an alkoxysilane compound and a hydrolyzed product thereof, a silane coupling agent and a hydrolyzed product thereof, and a fine particulate silica; and

the gas-barrier layer is a layer of a cured body obtained by curing a polysilazane compound (C) in the presence of an amine catalyst (D).

In the above transparent protective plate [I] for display panel, the following embodiments are, further, preferred.

(1) The underlying layer has a thickness of from 0.5 to 20 μm, and the gas-barrier layer has a thickness of from 0.05 to 2 μm; and
(2) The transparent hard resin substrate comprises a polymethyl methacrylate resin or an aromatic polycarbonate resin, or laminated layers of the polymethyl methacrylate resin and the aromatic polycarbonate resin.

According to the present invention, there is, further, provided a transparent protective plate [II] for display panel having an underlying layer, a gas-barrier layer and a transparent adhesive layer successively laminated on a transparent hard resin substrate, wherein:

the underlying layer comprises 90 to 20 parts by mass of an urethane acrylate adhesive resin (A), and 10 to 80 parts by mass of at least one silicon compound (B) selected from the group consisting of an alkoxysilane compound and a hydrolyzed product thereof, a silane coupling agent and a hydrolyzed product thereof, and a fine particulate silica; and

the gas-barrier layer is a layer of a cured body obtained by curing a polysilazane compound (C) in the presence of an amine catalyst (D).

In the above transparent protective plate [II] for display panel, the following embodiments are, further, preferred.

(3) The transparent adhesive layer comprises an acrylic adhesive agent;
(4) The underlying layer has a thickness of from 0.5 to 20 μm, and the gas-barrier layer has a thickness of from 0.05 to 2 μm; and
(5) The transparent hard resin substrate comprises a polymethyl methacrylate resin or an aromatic polycarbonate resin, or laminated layers of the polymethyl methacrylate resin and the aromatic polycarbonate resin.

According to the present invention, there is, further, provided a display device having a transparent adhesive layer, a gas-barrier layer, an underlying layer and a transparent hard resin substrate successively laminated on a display panel, wherein:

the underlying layer comprises a cured body obtained by polymerizing an underlying material that contains 90 to 20 parts by mass of an urethane acrylate adhesive resin (A), and 10 to 80 parts by mass of at least one silicon compound (B) selected from the group consisting of an alkoxysilane compound and a hydrolyzed product thereof, a silane coupling agent and a hydrolyzed product thereof, and a fine particulate silica; and

the gas-barrier layer is a layer of a cured body obtained by curing a polysilazane compound (C) in the presence of an amine catalyst (D).

In the above display device, it is desired that the display panel is a liquid crystal display panel or an electrostatic capacity-type touch panel.

The display device of the present invention has the basic structure as described above. Desirably, the transparent protective plate [I] for display panel and the display panel are such that the gas-barrier layer of the transparent protective plate [I] faces the surface of the display panel and is stuck thereto by using a transparent adhesive agent, or the transparent protective plate [II] is laminated on the display panel via the transparent adhesive layer.

### Effects of the Invention

The display device of the present invention not only excels in the visibility and impact resistance but also is capable of preventing the evolution of bubbles and peeling of protective plate under high temperature and high humidity conditions. As a result, the display device of the invention can be favorably used as a liquid crystal display device and as a touch panel for a car navigation system that is subject to be exposed to high temperature and high humidity conditions.

Further, the display device of the invention can be easily fitted to the surface of a display panel such as liquid crystal panel or touch panel, and there can be provided a transparent protective plate for display panel that can be used as a display device exhibiting the above-mentioned properties.

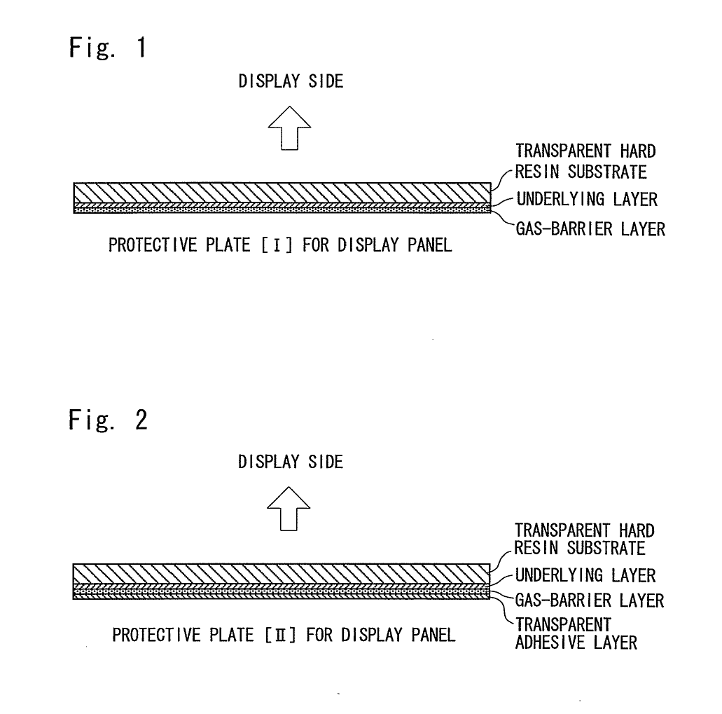

### BRIEF DESCRIPTION OF THE DRAWINGS

[FIG. 1] is a schematic view illustrating the structure in cross section of a transparent protective plate [I] for display panel.

[FIG. 2] is a schematic view illustrating the structure in cross section of a transparent protection plate [II] for display panel.

### MODES FOR CARRYING OUT THE INVENTION

A protective plate [I] for display panel of the invention is constituted by successively laminating an underlying layer and a gas-barrier layer on a transparent hard resin substrate.

### <Transparent Hard Resin Substrate>

There is no particular limitation on the transparent hard resin substrate provided it is made of a transparent hard resin that has excellent impact strength and does not hinder visibility. From the standpoint of transparency and impact strength, it is desired to use a substrate of a polymethyl methacrylate resin or an aromatic polycarbonate resin, or a substrate of laminated layers of the polymethyl methacrylate resin and the aromatic polycarbonate resin. As a concrete constitution of the substrate of laminated layers, there can be exemplified a substrate of laminated layers comprising the polymethyl methacrylate resin layer laminated on one surface of the aromatic polycarbonate resin layer, or a substrate of laminated layers comprising polymethyl methacrylate resin layers laminated on both surfaces of the aromatic polycarbonate resin layer.

The thickness of the substrate is suitably selected and designed from the standpoint of the required transparency and impact strength, and is, usually, set to lie in a range of from 0.5 to 3.0 mm.

### <Underlying Layer>

From the standpoint of close adhesion between a gas-barrier layer of a specific composition that will be described later and the above transparent hard resin substrate, it is important that the underlying layer comprises a cured body obtained by polymerizing an underlying material that contains 90 to 20 parts by mass of an urethane acrylate adhesive resin (A) and 10 to 80 parts by mass of a silicon compound (B), and that the silicon compound (B) is at least one compound selected from the group consisting of an alkoxysilane compound and a hydrolyzed product thereof, a silane coupling agent and a hydrolyzed product thereof, and a fine particulate silica.

If there is no underlying layer, the gas-barrier layer and the transparent hard resin substrate peel off from each other. Further, if the underlying material forming the underlying layer contains less than 20 parts by mass of the urethane acrylate adhesive resin (A) and not less than 80 parts by mass of the silicon compound, then the adhesion becomes poor not only under high temperature and high humidity conditions but also in the initial period, and the above two members peel off. If the amount of the acrylate adhesive resin (A) exceeds 90 parts by mass and the amount of the silicon compound is less than 10 parts by mass, the initial close adhesion is sufficient but peeling takes place under high temperature and high humidity conditions.

Therefore, the underlying material does not substantially work as the underlying layer if it is not constituted by 90 to 20 parts by mass of the urethane acrylate adhesive resin (A) and 10 to 80 parts by mass of at least one compound (B) selected from the group consisting of an alkoxysilane compound and a hydrolyzed product thereof, a silane coupling agent and a hydrolyzed product thereof, and a fine particulate silica.

The underlying layer must contain the urethane acrylate adhesive resin as an adhesive resin from the standpoint of not only attaining excellent initial adhesion to the gas-barrier layer that will be described later and, specifically, to the cured body of the polysilazane compound and close adhesion under high temperature/high humidity and heat-shock conditions but also preventing the occurrence of cracks in the gas-barrier layer. The effects of the invention are not exhibited if other adhesive resins are used.

The urethane acrylate adhesive resin (A) is typically a reactive resin comprising a polymerizable urethane acrylate compound (monomer) having an urethane bond in the molecules thereof and having a (meth)acrylate group at the terminals thereof, or an oligomer thereof or a prepolymer thereof prepared by the polyaddition reaction of an organoisocyanate compound having two or more isocyanate groups and a hydroxy group-containing acrylate compound.

Concretely, there can be exemplified phenylglycidyl ether (meth)acrylate hexamethylenediisocyanateurethane prepolymer, phenylglycidyl ether (meth)acrylate isophoronediisocyanateurethane prepolymer, phenylglycidyl ether (meth)acrylate tolylenediisocyanateurethane prepolymer; glycerine(meth)acrylate tolylenediisocyanateurethane oligomer, pentaerythritol tri(meth)acrylate hexamethylenediisocyanateurethane oligomer, glycerinedi(meth)acrylate isophoronediisocyanateurethane oligomer, pentaerythritol tri(meth)acrylate tolylenediisocyanateurethane oligomer, and pentaerythritol tri(meth)acrylate isophoronediisocyanateurethane preoligomer, which may be used alone or in a combination of two or more kinds.

The polymerizable urethane acrylate oligomers have been placed in the market and are, usually, available as, for example, Art Resins UN-3320HA, UN-3320HB, UN-3320HC, UN-3320HS, UN-904 [which are all produced by Negami Kogyo Co.]; UA-306H (pentaerythritol triacrylate hexamethylenediisocyanateurethane prepolymer), UA-306T (pentaerythritol triacrylate toluenediisocyanateurethane prepolymer), UA-306I (pentaerythritol triacrylate isophoronediisocyanateurethane prepolymer), UA-510H (dipentaerythritol pentaacrylate hexamethylenediisocyanateurethane prepolymer) [which are all produced by Kyoeisha Kagaku Co.]; UX-5000, UX-5002D-M20, UX-5003D, UX-5005, DPHA-40H [which are all produced by Nihon Kayaku Co.]; UV-1700B, UV-7550B, UV-7600B, UV-7605B, UV-7610B, UV-7620EA, UV-7630B, UV-7640B, UV-7650B [all produced by Nihon Gosei Kagaku Kogyo Co.]; U-4HA, U-6HA, U-6LPA, UA-1100H, UA-53H, UA-33H [all produced by Shin-Nakamura Kagaku Kogyo Co.].

The urethane acrylate adhesive resin (A) may be partly blended with a polyfunctional (meth)acrylate compound other than the above monomer, oligomer or prepolymer, in a range in which it does not impair the object of the present invention. Concrete examples thereof include pentaerythritol tri(meth)acrylate, dipentaerythritol tri(meth)acrylate, dipentaerythritol tetra(meth)acrylate, dipentaerythritol penta(meth)acrylate, trimethylolpropane tri(meth)acrylate, n-butyl (meth)acrylate, polyester (meth)acrylate, lauryl (meth)acrylate, and hydroxyethyl (meth)acrylate. These monomers may be used in one kind or in two or more kinds being mixed together.

As the alkoxysilane compound contained in the underlying material, there can be exemplified tetraalkoxysilane compounds such as tetraethoxysilane and tetramethoxysilane, and alkyltrialkoxysilane compounds such as methyltrimethoxysilane and methyltriethoxysilane.

The alkoxysilane compound may be a hydrolyzed product of the alkoxysilane compound that is partly or wholly hydrolyzed in the presence of an acid catalyst such as nitric acid or hydrochloric acid or an alkali catalyst such as sodium hydroxide or tetrabutylammonium bromide. There is no special limitation on the degree of hydrolysis of the hydrolyzed product. However, the degree of polymerization increases as the condensation polymerization proceeds together with the hydrolysis, and the solid component precipitates in the solution. Desirably, therefore, the degree of hydrolysis is to such an extent that no solid component precipitates.

As the silane coupling agent, there can be exemplified γ-methacryloxypropyltrimethoxysilane, γ-methacryloxypropylmethyldimethoxysilane, 3-acryloxypropyltrimethoxysilane, vinyltrimethoxysilane, vinyltriethoxysilane, p-styryltrimethoxysilane, γ-glycidoxypropyltrimethoxysilane, 2-(3,4-epoxycyclohexyl)ethyltrimethoxysilane, γ-glycidoxypropylmethyldimethoxysilane, 3-glycidoxypropylmethyldiethoxysilane, γ-aminopropyltrimethoxysilane, 3-aminopropyltriethoxysilane, N-2(aminoethyl) 3-aminopropylmethyldimethoxysilane, N-2(aminoethyl) 3-aminopropyltrimethoxysilane, N-2(aminoethyl) 3-aminopropyltriethoxysilane, 3-mercaptopropylmethyldimethoxysilane and 3-mercaptopropyltrimethoxysilane.

The silane coupling agent may be a hydrolyzed product of the silane coupling agent that is partly or wholly hydrolyzed in the presence of an acid catalyst such as nitric acid or hydrochloric acid or an alkali catalyst such as sodium hydroxide or tetrabutylammonium bromide. There is no special limitation on the degree of hydrolysis of the hydrolyzed product. However, the degree of polymerization increases as the condensation polymerization proceeds together with the hydrolysis, and the solid component precipitates in the solution. Desirably, therefore, the degree of hydrolysis is to such an extent that no solid component precipitates.

The fine particulate silica is a fine particulate colloidal silica having a particle size of from about 1 to about 50 nm. Usually, there is preferably used a colloidal silica sol suspended in a dispersion medium such as alcohol or water. For example, “Organosol” Series dispersed in an organic solvent and “Snowtechs” Series dispersed in water produced by Nissan Kagaku Kogyo Co. are available in the market. There can be, further, used “Quartron” produced by Fuso Kagaku Kogyo Co. and “OSCAL” Series produced by Nikki Shokubai Kasei Co. as colloidal silica sols.

The underlying material is a solution obtained by dissolving the above urethane acrylate adhesive resin (A), the silicon compound (B) and a photopolymerization initiator or a chemical polymerization initiator in a solvent such as toluene, methyl alcohol or butyl acetate. The underlying material solution is applied onto the transparent hard resin substrate, dried, and is, thereafter, cured by heating or by being irradiated with light. The underlying layer of the invention is thus formed. The thickness of the underlying layer is set to lie, usually, in a range of from 0.5 to 20 μm.

The underlying material solution may, as required, be blended with additives such as ultraviolet ray absorber, antioxidant, leveling agent, etc.

There is no specific limitation on the order of mixing or on the condition of mixing the above components; i.e., the components can be arbitrarily mixed and stirred at nearly room temperature to form the underlying material. When a colloidal silica sol placed in the market is used, the solvent which is a dispersing medium is inevitably mixed into the underlying material.

As the solvent to be used for the underlying material, there can be used an aromatic compound such as toluene or xylene which is highly capable of dissolving the urethane acrylate adhesive resin (A); an ester compound such as ethyl acetate, butyl acetate or isobutyl acetate; or a ketone compound such as acetone, MEK, MIBK or diacetone alcohol. There can be, further, used such a solvent as methylene glycol monomethyl ether acetate, ethylene glycol monomethyl ether acetate or propylene glycol monomethyl ether acetate.

As the solvent which is highly capable of dissolving the above silicon compound (B), there can be used an alcohol compound such as methanol, ethanol, NPA, IPA or butanol; or a cellosolve compound such as methyl cellosolve, ethyl cellosolve, or propylene glycol monomethyl ether.

In the underlying layer formed by curing by polymerization, the solvent is removed from the underlying solution in the above-mentioned step of drying. Though the polymerization initiator remains in the underlying layer, its amount is so small that no particular problem occurs.

There is no specific limitation on the method of applying the underlying material solution, and there can be employed such a method as dip coating method, roll coating method, die coating method, flow coating method or spray method. From the standpoint of quality of appearance and controlling the thickness of the film, however, the dip coating method is preferred.

### <Gas-Barrier Layer>

It is important that the gas-barrier layer of the invention is constituted by a cured body obtained by curing the polysilazane compound (C) in the presence of an amine catalyst (D).

The polysilazane compound (C) is a polymer with —(SiH₂—NH)— as a basic unit, and is a compound that easily reacts with water to convert into silica (silicon oxide). Concrete examples thereof include perhydropolysilazane without organic group, polysilazane in which an alkoxy group is bonded to a silicon atom, and polysilazane in which an alkyl group is bonded to a silicon atom or a nitrogen atom, and from which any one is selected depending upon desired properties. Among them, however, perhydropolysilazane is desired from the standpoint of strength and gas-barrier property. It is desired that the polysilazane compound (C) has a molecular weight of from 200 to 50,000 in terms of a number average molecular weight from the standpoint of solubility in a solvent and homogeneity of the obtained silica.

A catalyst is used to promote the conversion reaction of the polysilazane compound (C) into silica, and the present invention is characterized by the use of the amine catalyst (D). A metal catalyst such as palladium needs a high curing temperature. The curing at high temperatures, however, causes the underlying layer and the transparent hard resin substrate to be deteriorated, and is not desirable. The amine catalyst, on the other hand, permits the conversion reaction to undergo at low temperatures of from room temperature to 150° C., and is desirable.

As the amine catalyst, there can be used a monoalkylamine such as mono(n-butyl)amine, a dialkylamine such as dipentylamine, or a trialkylamine such as tributylamine. The amount of amine catalyst that is added is selected over a range of from 0.01 to 10 parts by mass and, preferably, from 0.05 to 5 parts by mass per 100 parts by mass of the polysilazane compound (C) by taking the effect of catalyst and transparency of the cured layer into consideration.

The polysilazane compound (C) and the amine catalyst (D) have been placed in the market in the form of solutions dissolved in organic solvents such as xylene and the like. It is, therefore, easy and desirable to use those that are available in the market. For example, they have been placed in the market by AZ Electronic Materials Co. in the name of “AQUAMICA” Series. Next, described below is a method of forming the gas-barrier layer according to the invention.

A solution for forming the gas-barrier layer (commercially available: solid content of about 10%) prepared by dissolving the polysilazane compound (C) and the amine catalyst (D) in an organic solvent, is applied onto the underlying layer by dip coating. After applied, the solution is, as required, dried and is, thereafter, heated at 80 to 100° C. for about 1 to about 25 hours to conduct the conversion reaction. As a result, the gas-barrier layer is formed substantially as a dense layer of silica which shuts off gases such as carbon dioxide gas and water vapor, and prevents the evolution of bubbles as well as peeling.

The thickness of the gas-barrier layer is set to lie in a range of from 0.05 to 2.0 μm from the standpoint of impermeability to various gases. There is no specific limitation on the method of applying the solution for forming the gas-barrier layer, and the solution is applied according to the above-mentioned method of applying the underlying material solution.

### <Transparent Adhesive Layer>

The protective plate [I] for display panel obtained by the above method is laminated with its gas-barrier layer facing the surface of the display panel that will be described later, and interposing a transparent adhesive layer between them. Though there is no special limitation, the thickness of the transparent adhesive layer is arbitrarily selected, usually, over a range of from 10 to 500 μm.

As the transparent adhesive layer, an acrylic adhesive agent is, desirably, used from the standpoint of high degree of transparency and high durability against ultraviolet rays and humidity. The acrylic adhesive agent is an adhesive which comprises an acrylic polymer as a basic component, and basically needs no tackifier. The acrylic polymer is a copolymer of three kinds of monomers of, typically, a higher alkyl acrylate such as butyl acrylate or 2-ethylhexyl acrylate that works as an adhesive component, a methyl (meth)acrylate or a vinyl acetate that works as a coagulating component, and an acrylic acid, a hydroxyethyl acrylate or an acrylic amide that works as a reforming component.

The acrylic adhesive agent may be dissolved in toluene or ethyl acetate to prepare a solution thereof which is then applied and dried to form a transparent adhesive layer. However, a highly transparent double-sided tape with both surfaces of the acrylic adhesive being sandwiched by removable films such as of polyethylene terephthalate is available in the market. It is, therefore, easy and desirable to use the above transparent double-sided tape to form the transparent adhesive layer. As the highly transparent double-sided tape placed in the market, there are available “Highly Transparent Double-Sided Tape #5400 Series” (produced by Sekisui Kagaku Kogyo Co.), “Highly Transparent Adhesive Sheet” (produced by Hitachi Kasei Co.), “Highly Transparent Adhesive Transfer Tape” (produced by 3M Co.), and the like. There is no specific limitation on the method of forming the transparent adhesive layer from the solution of the acrylic adhesive agent, and the transparent adhesive layer is formed according to the above-mentioned method of applying the underlying material solution.

The transparent protective plate [II] for display panel according to the invention has the underlying layer, gas-barrier layer and the above transparent adhesive layer successively laminated on the transparent hard resin substrate, and is the one in which the transparent adhesive layer is directly laminated on the gas-barrier layer of the above transparent protective plate [I] for display panel according to the above-mentioned method of forming the transparent adhesive layer.

As required, further, a secondary layer such as antireflection film may be laminated on the surfaces (visible surfaces) of the transparent protective plates [I] and [II] for display panel.

The transparent protective plates [I] and [II] for display panel of the invention are, usually, shipped and stored with their both surfaces being laminated with removable films such as of polyethylene terephthalate to prevent the surfaces from being scratched or from losing surface functions.

### <Display Device>

The display device according to the invention is desirably the one in which the transparent protective plate [I] or [II] for display panel is laminated on the display panel. The transparent protective plate [I] for display panel is laminated thereon by interposing a separately provided transparent adhesive layer between the two. In the case of the transparent protective plate [II] for display panel, the transparent adhesive layer present on the surface of the transparent protective plate [II] is directly press-adhered onto the display panel so as to be laminated thereon.

As the display panel, there can be used, without limitation, any widely known display panels such as liquid crystal panels and touch panels for cell phones and car navigation systems irrespective of their systems or structures. In the case of the liquid crystal panels, in general, the transparent protective plate [I] or [II] for display panel of the invention is laminated on the polarizing plate or on the glass constituting the panel. In the case of the touch panel, the transparent protective plate is directly laminated on the surface of the touch panel on the touch side.

### EXAMPLES

The invention will now be described by way of the following Examples which, however, are only for explanatory purposes, and the present invention is in no way limited thereto only. Further, it does not mean that the combinations of the features mentioned in Examples are all essential for the means for solving the problems of the invention.

The components, their abbreviations and testing methods used in the following Examples and Comparative Examples are as described below.

### (A) Urethane Acrylate Adhesive Resins:

A-1: Urethane oligomer polyacrylate “UN-3320HA” (produced by Negami Kogyo Co.)
A-2: Urethane oligomer polyacrylate “UN-904” (produced by Negami Kogyo Co.)
A-3: Pentaerythritol triacrylatehexamethylene diisocyanateurethane prepolymer “UA-306H” (produced by Kyoeisha Kagaku Co.)
A-4: Pentaerythritol triacrylateisophoron diisocyanateurethane prepolymer “UA-306I” (produced by Kyoeisha Kagaku Co.)
A-5: “UX-5000” (produced by Nihon Kayaku Kogyo Co.)
A-6: “UV-1700B” (produced by Nihon Gosei Kayaku Kogyo Co.)
A-7: “UV-7600B” (produced by Nihon Gosei Kayaku Kogyo Co.)
A-8: “UA-1100H” (produced by Shin-Nakamura Kagaku Kogyo Co.)
A-9: “UA-53H” (produced by Shin-Nakamura Kagaku Kogyo Co.)

### (B) Silicon Compounds:

B-1: Tetraethoxysilane (produced by Wako Junyaku Co.)
B-2: γ-Methacryloxypropyltrimethoxysilane “KBM-503” (produced by Shin-etsu Kagaku Co.)
B-3: Colloidal Silica Sol “IPA-ST” (produced by Nissan Kagaku Kogyo Co.: solid content, 30%)
B-4: A reaction product (homogeneous solution) obtained by hydrolyzing 100 parts by weight of a γ-glycidoxypropyltrimethoxysilane with 22.9 parts by weight of 0.02N hydrochloric acid at room temperature
B-5: A reaction product (homogeneous solution) obtained by hydrolyzing 100 parts by weight of a 3-methacryloxypropyltrimethoxysilane with 21.8 parts by weight of 0.02N hydrochloric acid at room temperature
B-6: 3-Aminopropyltrimethoxysilane
B-7: A reaction product (homogeneous solution) obtained by hydrolyzing 100 parts by weight of a 2-(3,4 epoxycyclohexyl)ethyltrimethoxysilane with 22.0 parts by weight of 0.02N hydrochloric acid at room temperature
B-8: A reaction product (homogeneous solution) obtained by hydrolyzing 100 parts by weight of a γ-glycidoxypropyltrimethoxysilane with 11.4 parts by weight of 0.05N hydrochloric acid at room temperature
B-9: A reaction product (homogeneous solution) obtained by hydrolyzing 100 parts by weight of a 3-acryloxypropyltrimethoxysilane with 11.5 parts by weight of 0.05N hydrochloric acid at room temperature

### (C) Photopolymerization Initiator:

C-1: 1-Hydroxy-cyclohexyl-phenyl-ketone “Irugacure 184” (produced by Chiba Japan Co.)

### (D) Solvents:

D-1: Toluene
D-2: Isopropyl alcohol
D-3: Methyl alcohol
D-4: Butylacetic ester

### (E) Mixtures of Polysilazane Compound and Catalyst:

E-1: Polysilazane/amine catalyst “Aquamica NP110” (produced by AZ Electronic Materials Co.; solid content, 10%, xylene solvent)
E-2: Polysilazane/amine catalyst “Aquamica NAX110” (produced by AZ Electronic Materials Co.; solid content, 10%, xylene solvent)
E-3: Polysilazane/palladium catalyst “Aquamica NL110” (produced by AZ Electronic Materials Co.; solid content, 10%, xylene solvent)

### (F) Transparent Adhesive Agent:

F-1: Acrylic adhesive agent “Highly Transparent Double-Sided Tape #5410” (produced by Sekisui Kagaku Kogyo Co., film thickness, 100 μm)

### (G) Transparent Hard Resin Substrates:

PC: Polycarbonate plate “Upilon NF2000” (produced by Mitsubishi Gas Kagaku Co.; thickness, 2.0 mm, 100×100 mm)
PMMA: Polymethylmethacrylate plate “Acrylite L001” (produced by Mitsubishi Rayon Co.; thickness, 2.0 mm, 100×100 mm)

### [Testing the Initial Adhesion of the Gas-Barrier Layer]

The underlying material solution was applied onto the transparent hard resin substrate, dried thereon, and was irradiated with ultraviolet rays so as to be cured to thereby form an underlying layer. Next, a solution composition for forming a gas-barrier layer was applied onto the underlying layer, and was cured at a predetermined temperature for a predetermined period of time to form the gas-barrier layer. The formed gas-barrier layer was scratched with a cutter knife longitudinally and transversely in a tessellated manner to cross at right angles (cross cut). A cellophane tape of a width of 24 mm produced by Nichiban Co. was stuck thereon in a manner that no bubbles were trapped therein, and was removed at one time. The operation was repeated three times and the adhesion was judged on the following basis.
◯: The gas-barrier layer was not peeled even one time.
X: The gas-barrier layer was partly peeled at least one time.

### [Testing the Adhesion of the Gas-Barrier Layer Under High Temperature and High Humidity Conditions]

The transparent protective plate for display panel having the gas-barrier layer formed by the above method was left to stand still in a thermo-hygrostat (manufactured by Tabeiespec Co., oven type) maintaining an environment of a temperature of 65° C. and a humidity of 90% for 72 hours. After left to stand still, the protective plate was taken out, returned to normal temperature and was, thereafter, cut in a tessellated manner by the above method to judge the adhesion on the same basis.

### [Testing the Evolution of Gas]

The surface of the gas-barrier layer of the transparent protective plate for display panel forming the gas-barrier layer by the above method was stuck to the soda glass by using the transparent adhesive agent (tape). The structure was held under the same condition as the one for the testing of adhesion under the above high temperature and high humidity conditions and was, thereafter, taken out and was observed with the eye to confirm the evolution of bubbles.
YES: Presence of bubbles was confirmed.
NO: No bubble was confirmed with the eye.

### Example 1

A polycarbonate resin plate was dip-coated with an underlying material solution obtained by dissolving 60 parts by mass of an urethane oligomer polyacrylate (UN-3320HA; produced by Negami Kogyo Co.), 40 parts by mass of a tetraethoxysilane (produced by Wako Jun-yaku Co.) and 2.4 parts by weight of a 1-hydroxy-cyclohexyl-phenyl-ketone “Irugacure 184” (produced by Chiba Japan Co.) in a toluene•isopropyl alcohol mixed solvent (116.7 parts by mass of toluene, 116.7 parts by mass of isopropyl alcohol) at room temperature. After dried at 70° C. for 10 minutes, the underlying material solution was irradiated with an ultraviolet ray of 300 mj/cm² by using a “UV irradiation apparatus” (manufactured by Eye Graphics Co.) at room temperature so as to be polymerized and cured to thereby form an underlying layer of a thickness of 3 μm. Next, the underlying layer was dip-coated with a solution for forming a gas-barrier layer containing polysilazane and amine catalyst “Aquamica NP110” (produced by AZ Electronic Materials Co.; solid content, 10%, xylene solution), and was reacted in a 100° C. hot air circulating oven for 5 hours to thereby form a gas-barrier layer. The formed gas-barrier layer possessed a thickness of 1 μm.

The obtained transparent protective plate for display panel was tested for its adhesion in accordance with the above-mentioned testing method. Further, the soda glass was used to substitute for the display panel, and the gas-barrier layer of the transparent protective plate was stuck to the soda glass to confirm the evolution of gas in accordance with the above testing method. With the use of a laminator, the gas-barrier layer was stuck to the glass by using an acrylic adhesive agent “Highly Transparent Double-Sided Tape #5410” (film thickness of 100 μm; produced by Sekisui Kagaku Kogyo Co.). Table 1 also shows the evaluated results.

### Examples 2 to 6, Comparative Examples 1 to 7

Transparent protective plates for display panel were prepared in accordance with Example 1 by using transparent hard resin substrates, underlying material solutions, solutions for forming gas-barrier layer and a transparent adhesive agent (tape) shown in Table 1, and were evaluated in the same manner as in Example 1. Table 1 also shows thicknesses of the formed layers and the evaluated results.

TABLE 1

| | Ex. 1 | Ex. 2 | Ex. 3 | Ex. 4 | Ex. 5 | Ex. 6 |
|---|---|---|---|---|---|---|
| (*a) | | | | | | |
| PC | ◯ | ◯ | ◯ | ◯ | — | — |
| PMMA | — | — | — | — | ◯ | ◯ |
| (*b) | | | | | | |
| A-1 | 60 | 50 | — | — | 90 | — |
| A-2 | — | — | 60 | 50 | — | 20 |
| B-1 | 40 | — | — | — | 10 | — |
| B-2 | — | 50 | — | 10 | — | 80 |
| B-3 | — | — | 133.3*¹ | 133.3*¹ | — | — |
| C-1 | 2.4 | 2 | 2.4 | 2.4 | 3.6 | 4 |
| D-1 | 116.7 | 116.7 | 116.7 | 116.7 | — | — |
| D-2 | 116.7 | — | 23.3 | 23.3 | 200 | 200 |
| D-3 | — | 116.7 | — | — | — | — |
| D-4 | — | — | — | — | 200 | 200 |
| (*c) | 3 | 3 | 3 | 3 | 2 | 2 |
| (*d) | | | | | | |
| E-1 | ◯ | ◯ | — | — | — | — |
| E-2 | — | — | ◯ | ◯ | ◯ | ◯ |
| E-3 | — | — | — | — | — | — |
| (*e) | 1 | 1 | 1 | 1 | 1 | 1 |
| (*f) | | | | | | |
| F-1 | ◯ | ◯ | ◯ | ◯ | ◯ | ◯ |
| (*g) | | | | | | |
| (*h) | ◯ | ◯ | ◯ | ◯ | ◯ | ◯ |
| (*i) | | | | | | |
| (*j) | ◯ | ◯ | ◯ | ◯ | ◯ | ◯ |
| (*k) | ◯ | ◯ | ◯ | ◯ | ◯ | ◯ |
| (*l) | no | no | no | no | no | no |

| | Comp. | Comp. | Comp. | Comp. | Comp. | Comp. | Comp. |
|---|---|---|---|---|---|---|---|
| | Ex. 1 | Ex. 2 | Ex. 3 | Ex. 4 | Ex. 5 | Ex. 6 | Ex. 7 |
| (*a) | | | | | | | |
| PC | ◯ | ◯ | ◯ | ◯ | ◯ | ◯ | ◯ |
| PMMA | — | — | — | — | — | — | — |
| (*b) | | | | | | | |
| A-1 | — | — | — | — | — | 60 | 60 |
| A-2 | — | — | 100 | — | 15 | — | — |
| B-1 | — | — | — | 100 | — | 40 | 40 |
| B-2 | — | — | — | — | — | — | — |
| B-3 | — | — | — | — | 283.3*² | — | — |
| C-1 | — | — | 4 | — | 0.6 | 2.4 | 2.4 |
| D-1 | — | — | — | — | — | 116.7 | 116.7 |
| D-2 | — | — | 233.3 | — | — | 116.7 | 116.7 |
| D-3 | — | — | — | — | — | — | — |
| D-4 | — | — | 233.3 | — | 35 | — | — |
| (*c) | 0 | 0 | 5 | 2 | 2 | 3 | 3 |
| (*d) | | | | | | | |
| E-1 | — | ◯ | ◯ | ◯ | — | — | — |
| E-2 | — | — | — | — | ◯ | — | — |
| E-3 | — | — | — | — | — | — | ◯ |
| (*e) | 0 | 1 | 1 | 1 | 1 | 0 | 1 |
| (*f) | | | | | | | |
| F-1 | ◯ | ◯ | ◯ | ◯ | ◯ | ◯ | ◯ |
| (*g) | | | | | | | |
| (*h) | ◯ | ◯ | ◯ | ◯ | ◯ | ◯ | ◯ |
| (*i) | | | | | | | |
| (*j) | ◯ | ◯ | ◯ | X | X | ◯ | ◯ |
| (*k) | X | X | X | X | X | ◯ | ◯ |
| (*l) | yes | no | no | no | yes | yes | yes |

*¹solid content, 40 parts by mass
*²solid content, 85 parts by mass
(*a): Resin substrate,
(*b): Composition of underlying material solution (pts. by wt.),
(*c): Thickness of underlying layer (μm),
(*d): Solution for forming gas-barrier layer,
(*e): Thickness of gas-barrier layer (μm),
(*f): Transparent adhesive,
(*g): Display panel,
(*h): soda glass,
(*i): Evaluation,
(*j): adhesiveness (initial),
(*k): adhesiveness (hi. temp. hi. humidity),
(*l): evolution of gas

In Comparative Example 2 without the underlying layer, evolution of gas was not confirmed but the adhesiveness was poor from the initial stage. When no silicon compound was contained in the underlying layer, the adhesiveness was poor under high temperature and high humidity conditions (Comparative Example 3). When the silicon compound was present in an excess amount relative to the urethane acrylate adhesive resin, the adhesiveness was poor from the initial stage and, besides, evolution of gas could not be prevented (Comparative Example 5). When no urethane acrylate adhesive resin was contained in the underlying layer, the adhesiveness was poor from the initial stage (Comparative Example 4). When no gas-barrier layer was present, evolution of gas could not be prevented (Comparative Example 6). When the gas-barrier layer was formed by using the palladium catalyst, the conversion did not take place to a sufficient degree at about 100° C., and the gas-barrier function was not fully exhibited (Comparative Example 7).

### Examples 7 to 13

Transparent protective plates for display panel were prepared in accordance with Example 1 by using the transparent hard resin substrate, underlying material solutions, a solution for forming gas-barrier layer and a transparent adhesive agent (tape) shown in Table 2, and were evaluated in the same manner as in Example 1. Table 2 also shows thicknesses of the formed layers and the evaluated results.

Favorable results were obtained when the underlying layers were formed by using a hydrolyzed product of the alkoxysilane compound and a hydrolyzed product of the silane coupling agent, too.

TABLE 2

| | Ex. 7 | Ex. 8 | Ex. 9 | Ex. 10 | Ex. 11 | Ex. 12 | Ex. 13 |
|---|---|---|---|---|---|---|---|
| (*a) | | | | | | | |
| PC | ◯ | ◯ | ◯ | ◯ | ◯ | ◯ | ◯ |
| (*b) | | | | | | | |
| A-3 | 70 | | | | | | |
| A-4 | | 70 | | | | | |
| A-5 | | | | | | 80 | |
| A-6 | | | | 70 | | | |
| A-7 | | | | | 80 | | |
| A-8 | | | 70 | | | | |
| A-9 | | | | | | | 80 |
| B-3 | 100 | | | | | | |
| B-4 | | 36.5 | | | | | |
| B-5 | | | 36.1 | | | | |
| B-6 | | | | 30 | | | |
| B-7 | | | | | 24.1 | | |
| B-8 | | | | | | 22 | |
| B-9 | | | | | | | 21.9 |
| C-1 | 3.5 | 3.5 | 3.5 | 3.5 | 4 | 4 | 4 |
| D-1 | 116.7 | 116.7 | 116.7 | 116.7 | 116.7 | 116.7 | 116.7 |
| D-2 | 46.7 | 110.2 | 110.6 | 116.7 | 112.6 | 114.7 | 114.8 |
| (*c) | 3 | 3 | 3 | 3 | 3 | 3 | 3 |
| (*d) | | | | | | | |
| E-1 | ◯ | ◯ | ◯ | ◯ | ◯ | ◯ | ◯ |
| (*e) | 1 | 1 | 1 | 1 | 1 | 1 | 1 |
| (*f) | | | | | | | |
| F-1 | ◯ | ◯ | ◯ | ◯ | ◯ | ◯ | ◯ |
| (*g) | | | | | | | |
| (*h) | ◯ | ◯ | ◯ | ◯ | ◯ | ◯ | ◯ |
| (*i) | | | | | | | |
| (*j) | ◯ | ◯ | ◯ | ◯ | ◯ | ◯ | ◯ |
| (*k) | ◯ | ◯ | ◯ | ◯ | ◯ | ◯ | ◯ |
| (*l) | no | no | no | no | no | no | no |

(*a): Resin substrate,
(*b): Composition of underlying material solution (pts. by wt.),
(*c): Thickness of underlying layer (μm),
(*d): Solution for forming gas-barrier layer,
(*e): Thickness of gas-barrier layer (μm),
(*f): Transparent adhesive,
(*g): Display panel,
(*h): soda glass,
(*i): Evaluation,
(*j): adhesiveness (initial),
(*k): adhesiveness (hi. temp. hi. humidity),
(*l): evolution of gas

1. A transparent protective plate for display panel having an underlying layer and a gas-barrier layer successively laminated on a transparent hard resin substrate, wherein:
said underlying layer comprises a cured body obtained by polymerizing an underlying material that contains 90 to 20 parts by mass of an urethane acrylate adhesive resin (A), and 10 to 80 parts by mass of at least one silicon compound (B) selected from the group consisting of an alkoxysilane compound and a hydrolyzed product thereof, a silane coupling agent and a hydrolyzed product thereof, and a fine particulate silica; and
said gas-barrier layer is a layer of a cured body obtained by curing a polysilazane compound (C) in the presence of an amine catalyst (D).

2. The transparent protective plate for display panel according to claim 1, wherein a transparent adhesive layer is laminated on said gas-barrier layer.

3. The transparent protective plate for display panel according to claim 2, wherein the transparent adhesive layer comprises an acrylic adhesive agent.

4. The transparent protective plate for display panel according to claim 1, wherein the underlying layer has a thickness of from 0.5 to 20 μm, and the gas-barrier layer has a thickness of from 0.05 to 2 μm.

5. The transparent protective plate for display panel according to claim 1, wherein the transparent hard resin substrate is a substrate of a polymethyl methacrylate resin or an aromatic polycarbonate resin, or a substrate of laminated layers of the polymethyl methacrylate resin and the aromatic polycarbonate resin.

6. A display device having a transparent adhesive layer, a gas-barrier layer, an underlying layer and a transparent hard resin substrate successively laminated on a display panel, wherein:
said underlying layer comprises a cured body obtained by polymerizing an underlying material that contains 90 to 20 parts by mass of an urethane acrylate adhesive resin (A), and 10 to 80 parts by mass of at least one silicon compound (B) selected from the group consisting of an alkoxysilane compound and a hydrolyzed product thereof, a silane coupling agent and a hydrolyzed product thereof, and a fine particulate silica; and
said gas-barrier layer is a layer of a cured body obtained by curing a polysilazane compound (C) in the presence of an amine catalyst (D).

7. The display device according to claim 6, wherein the display panel is a liquid crystal display panel or an electrostatic capacity-type touch panel.
